(19) United States
(12) Patent Application Publication
(10) Pub. No.: US 2008/0169133 A1
(43) Pub. Date: Jul. 17, 2008

(54) Head wind engine booster with plural fans

(76) Inventor: Yoshioki Tomoyasu, Fujisawa-shi (JP)

Correspondence Address: Yoshioki Tomoyasu, 21-22, Mirokuji 3-chome, Fujisawa-shi, Kanagawa-ken, 251-0016, omitted

(21) Appl. No.: 11/652,929

(22) Filed: Jan. 16, 2007

(51) Int. Cl. B60K 16/00

(52) U.S. Cl. 180/2.2

(57) ABSTRACT

The invention is related to the driving force booster for the vehicle using fans fixed on the rotating shaft of a vehicle to convert head wind into additional driving force by means of rotating fans with blowing power of said head wind in the driving operation of said vehicle.

### FIELD OF THE INVENTION

The invention relates to systems for driving vehicles to direct developing for saving energy for driving operation of said vehicles and reducing subsequent exhausting gases causing air pollution in view of global environment.

### BACKGROUND OF THE INVENTION

The heavy fuels consumption caused by vehicles in driving operation arises in broad range of problems such air pollution as contaminated with exhausting gases entailed and considerable decrease for natural resources. For solution to these problems involved, developments have been required for new technology enabling to save fuels and decreasing subsequent exhausting gases in the driving operation of said vehicles such as hybrid cars and diesel engine motor cars.

### Description of the Prior Art

Many technical developments for reducing fuels required for driving operation for vehicles among many motor car manufacturers have been made, particularly decreasing the volume of CO₂ as well as other harmful chemical compounds contained in the exhausting gases. Whereas, the sufficient effects on the technical development for solving the problem have not yet been attained due to the reason why the solving method developed by many car manufacturers are most likely to depend on improving devices for directing to take advantage of energy with higher efficiency than the conventional one of which capacity is liable to be confined within a limit, thus the technical advancement made above set forth applied to the actual driving operation of said vehicles still remain in moderate extent of the level required for vehicles.

### SUMMARY OF THE INVENTION

The present invention is related to boost the driving power of the conventional vehicles without supplementing with further fuels by means of using fans installed on a single or plural shafts arranged on the front of said vehicle of which function is to convert head wind into the additional driving force produced by operating the blades of said fans to directly rotate said shafts with the sequent wind flow which otherwise would become resistance against the driving operation of said vehicles.

Therefore, the above set forth additional driving force converted by said head wind is in proportion to the total area covered with circulating operation by blades of said fans, thus a plural number of fans geared with the driving shaft of said vehicles are liable to produce additional driving force on the condition that the fans on the subsequent shafts are allowed to be installed inside space of said vehicles. As far as fans arranged in series on a single shaft is concerned, the power of rotating shaft with the wind flow is available at higher efficiency attributable to the fact that the behind fan is to be rotated with the sequent wind flow brushed by among the blades of the before fun which otherwise would turn to be resistance to the driving operation of said vehicle.

### BRIEF DESCRIPTION OF THE DRAWINGS

FIG. 1: One example of the flat sectional view of the vehicle applied with the Head Wind Engine Booster with the front fans and the supplementary fans.

### DETAILED DESCRIPTION OF THE INVENTION

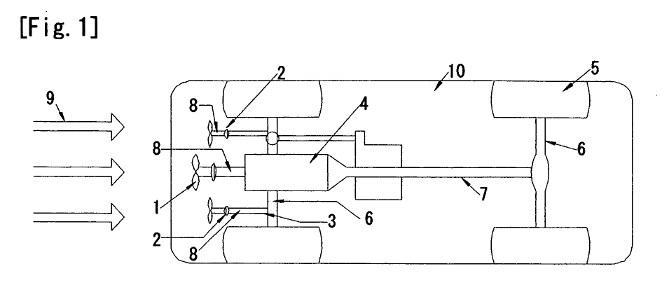

As shown FIG. 1, the present invention is directed to developing for the strong power of driving engine (4) for the vehicle (10) by means of installing fans consisting of the front fan (1) and the supplementary fan (2) on the rotating shafts (8) converting the head wind (9) into driving force in driving operation of said vehicle (10). Said head wind (8) operates to rotate said fans (1,2) connected with either the driving shaft (6) or the propeller shaft (7) with gear (3) connected with the tires (5) to provide the additional driving power to said vehicle (10) without supplementing further fuels entailed with exhausting gases, thus saving fuels and eliminating occurrence of CO₂ as well as other harmful exhausting gases.

The reason why a plural front fans (1) are installed on respective rotating shaft (8) is attributable to the fact that said head wind (9) converted into the additional driving force is confined to the area covered with circulating operation of blades of said front fans (1) and otherwise head wind (9) remains as resistance to the driving force of said vehicle (10), thus higher efficiency for converting said head wind (9) is available for plural units of fans (1) instead of single one (1) due to the fact that wider space occupied with the area covered with the circulation of blades of said fans (1) is required for being kept.

As far as plural units of fans (2) on the rotating shaft (8) in series are concerned, higher efficiency of rotating shafts (8) is available in rotating operation due to the fact that the supplementary fans (2) are operated with the sequent blowing head wind (9) brushed by among the blades of said front fans (1) which otherwise would turn to the resistance to the rotating operation. Furthermore, smooth driving operation for said vehicles (10) is possible converting lengthwise vibration caused by the piston-driven engine into rotating operation of fans (1) possible to eliminate the need for the flywheel of which function is to keep inertia to cover intervals of reciprocating movement of said pistons of the engine (4) of said vehicles (10) while reducing the number of cylinders of the conventional vehicles.

In this connection, our wind channel test data executed and issued by the Japan Automobile Research Institute (public organization) to whom we consigned represent the findings that approximate 30% of the driving force of vehicles (10) for the area covered with the circulating operation of blades of said the front fan (1) of said vehicle (10) is reduced by means of converting said head wind (9) into the additional rotating power for said fans (1), thus larger space covered with the circulating operation of blades of said fans (1, 2) inside of said vehicle assure said vehicle of boosting driving force without any supplement of fuels.

The present invention is applicable to any type of vehicles such as the piston-driven engines, diesel engines, hybrid cars, pick up trucks, hybrid cars and electric vehicles with supplementing additional driving power.

1. Head wind engine booster with plural units of fan means defining a device for a booster to increase driving force of a vehicle by means of installing a plural number of units of fan on a respective shaft arranged in parallel with the rotating shaft driven by the force to be supplied with power source such as an engine and a battery geared with either a driving or an axle shaft of said vehicle with rear end thereof to be provided with the additional driving force converted from the head wind which operate to rotate the blades of said fans with the wind power caused by against the driving operation of said vehicle.

2. A plural units of fans are installed on a respective shaft in series in the front position with the blades of said fan in different phases to operate the blades of the behind the fan fitted on the identical shaft with the sequent head wind brushed by among the blades of the before fan in the driving operation of said vehicle to be converted into additional driving force to be directly transmitted into either driving or axle shafts of said vehicles.

3. The lengthwise movement of the reciprocating piston in a cylinder of the piston driven engine of a vehicle is converted into the rotational movement by the fan installed in the front position on a rotating shaft substituted for the function of a flywheel to reduce the number of cylinders of said engine of said vehicle assisted by the driving force converted the head wind into rotating force of said fan with less consumption of fuels and noise occurred in the driving operation of said vehicle.
